(19) United States
(12) Patent Application Publication
(10) Pub. No.: US 2023/0159310 A1
(43) Pub. Date: May 25, 2023

(54) WINCH ENGAGEMENT APPARATUS

(71) Applicant: Hiromi Higo, Chilliwack (CA)

(72) Inventor: Hiromi Higo, Chilliwack (CA)

(21) Appl. No.: 17/456,216

(22) Filed: Nov. 23, 2021

(51) Int. Cl. B66D 1/04; B66D 1/74

(52) U.S. Cl. CPC B66D 1/04; B66D 1/7473

(57) ABSTRACT

A winch engagement apparatus that is configured to be operably coupled to a strap winch on a flatbed trailer wherein the present invention provides a technique to rotationally move the shaft on the strap winch so as to tighten a strap. The present invention includes a housing wherein the housing has a first side and a second side. A passage is present through the housing and extends between the first side and the second side having openings at each end thereof. The passage is configured to surroundably mount a portion of a shaft present on the strap winch. Engagement levers are present wherein the engagement levers are pivotally secured to the housing. The engagement levers includes a hole engagement edge that is operable to penetrate a hole formed on the shaft portion in order to operably lock the housing into position so a rotational force can be applied.

### FIELD OF THE INVENTION

The present invention relates generally to securing devices, more specifically but not by way of limitation, an apparatus that is configured to engage a winch on a flatbed trailer wherein the apparatus facilitates operation of the winch so as to secure a strap over a cargo load.

### BACKGROUND

Millions of tractor trailers traverse the roads everyday carrying various types of cargo to their destination. There are different types of trailers that are utilized to transport the alternate types of cargo. Palletized loads, boxes and similar types of cargo are most often carried in conventional box trailers that are completely enclosed. Another type of frequently utilized trailer is a flatbed trailer. These types of trailers are utilized for materials that cannot be palletized such as but not limited to lumber and pipe. The flatbed trailer is configured to receive the load superposed on the upper surface and the load is subsequently secured thereto.

One issue with securing cargo to a flatbed trailer is the utilization of straps. Most flatbed trailers have deployed along the sides thereof nylon strap rolls and winches on the opposing side. The straps are configured to extend over the load and be operably coupled with the winch wherein the winch is utilized to tighten the strap across the load so as to secure the load in place. The conventional winches coupled to flatbed trailers have a shaft that extends outward from the mounting bracket. The portion of the shaft that extends beyond the mounting bracket has apertures journaled therethrough. These apertures are utilized to place a bar or similar device to rotate the shaft so as to facilitate the tightening of the strap across the load. One problem with operation of the winch with a bar is the increased time required as constant removal/re-insertion of the bar is required during the strap tightening process. Range of motion of the bar can be limited by structure of the trailer and further can cause injury during the strap tightening process.

It is intended within the scope of the present invention to provide a winch engagement apparatus that is configured to engage the shaft portion of the winch of a flatbed trailer wherein the present invention facilitates the operation thereof with reduced time and opposing rotational capabilities.

### SUMMARY OF THE INVENTION

It is the object of the present invention to provide a winch engagement apparatus that is configured to operably couple to a winch on a flatbed trailer wherein the present invention includes a housing manufactured from metal or similar durable material.

Another object of the present invention is to provide an apparatus that is operable to facilitate the tightening of a strap through operational engagement of a winch wherein the housing of the present invention includes a hollow passage therethrough having an opening on opposing sides of the housing.

A further object of the present invention is to provide a winch engagement apparatus that is configured to operably couple to a winch on a flatbed trailer wherein the housing includes an engagement lever movably coupled therein.

Still another object of the present invention is to provide an apparatus that is operable to facilitate the tightening of a strap through operational engagement of a winch wherein the engagement lever is pivotally coupled to the housing and is shaped so as to self center in the apertures of the shaft of the winch.

An additional object of the present invention is to provide a winch engagement apparatus that is configured to operably couple to a winch on a flatbed trailer wherein the engagement lever includes a distal end that is rounded in form.

Yet a further object of the present invention is to provide an apparatus that is operable to facilitate the tightening of a strap through operational engagement of a winch wherein the engagement lever includes an aperture penetrating portion that propagates into one of the apertures on the shaft of the winch.

Another object of the present invention is to provide a winch engagement apparatus that is configured to operably couple to a winch on a flatbed trailer wherein the present invention includes an arm member secured to the housing.

An alternate object of the present invention is to provide an apparatus that is operable to facilitate the tightening of a strap through operational engagement of a winch wherein the arm member extends outward from the housing and is utilized to engage the present invention to provide rotational movement of the shaft of the winch.

Still a further object of the present invention is to provide a winch engagement apparatus that is configured to operably couple to a winch on a flatbed trailer wherein the housing of the present invention can be positioned to operably couple the shaft of a winch from a first side and a second side of the housing.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a cross sectional diagrammatic view of the first side of the housing; and

FIG. 2 is a cross sectional diagrammatic view of the second side of the housing; and

FIG. 3 is a perspective view of the present invention; and

FIG. 4 is a side view of the first side of the housing; and

FIG. 5 a top view of the first side and second side of the housing; and

FIG. 6 is a side view of the second side of the housing; and

FIG. 7 is a diagrammatic view of a portion of the handle and housing of the present invention; and

FIG. 8 is a diagrammatic view of a portion of the handle and housing of the present invention; and

FIG. 9 is a diagrammatic view of a portion of the handle and housing of the present invention; and

FIG. 10 perspective view of the present invention.

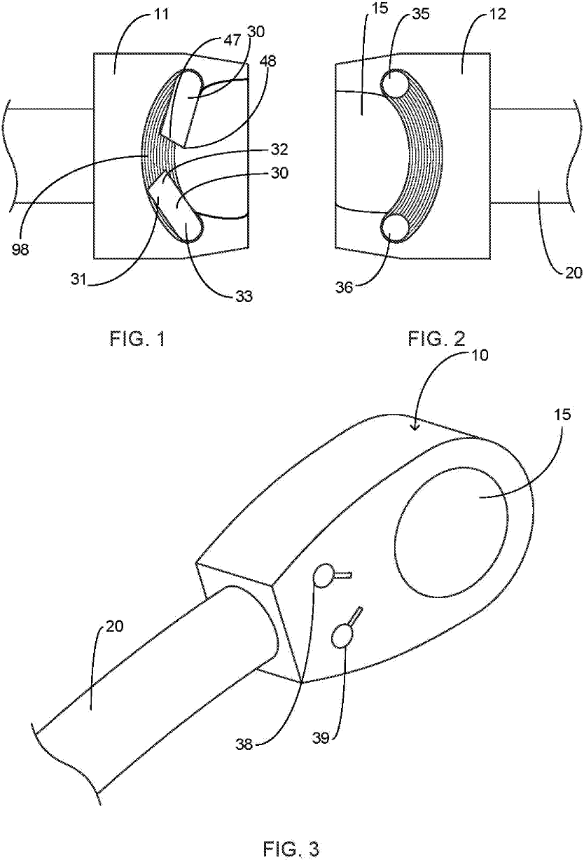

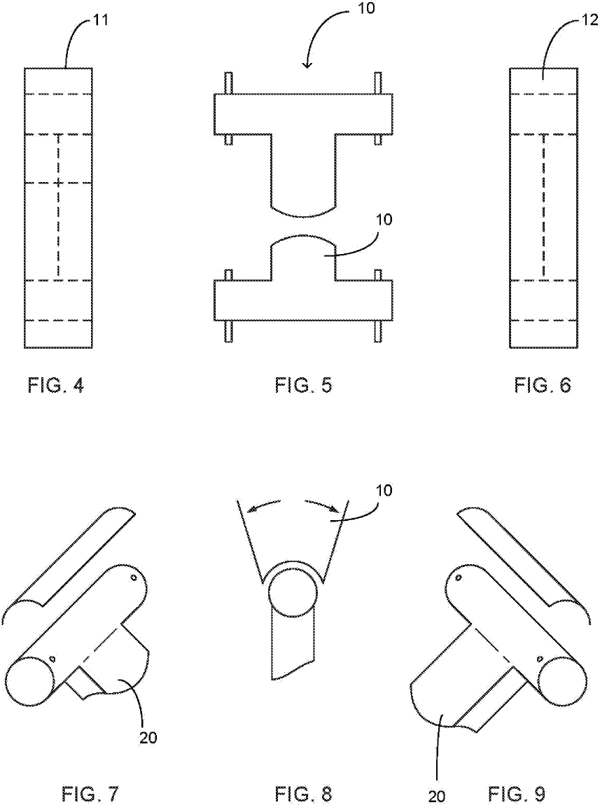

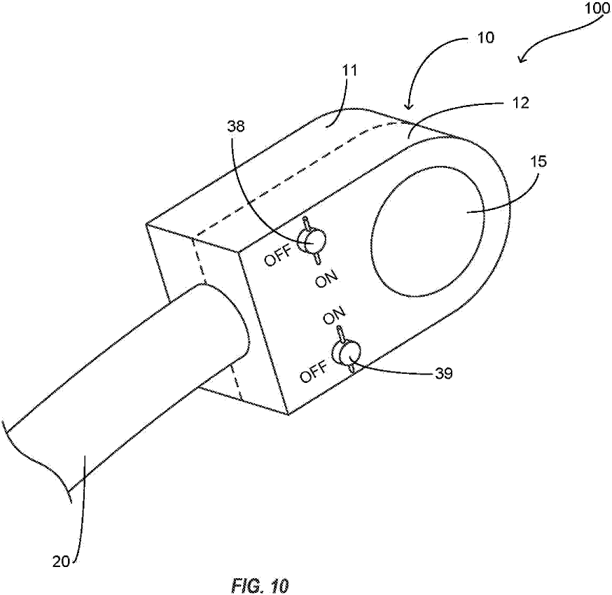

### DETAILED DESCRIPTION

References now to the drawings submitted herewith, wherein various elements depicted therein are not necessarily drawn to scale and wherein through the views and figures like elements are referenced with identical reference numerals, there is illustrated a winch engagement apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the Figures submitted herewith, the winch engagement apparatus 100 is configured to operably engage a conventional strap winch. As is known in the art, conventional strap winches include a mounting bracket that is operable to secure the strap winch an underside of a trailer. Most strap winches include pinion gears, strap engagement rods and a shaft including a portion extending beyond a mounting bracket having apertures or other similar element that can be engaged to provide rotation of the shaft and as such tightening of a strap coupled thereto. The winch engagement apparatus 100 is configured to provide operation of the aforementioned conventional strap winch.

The winch engagement apparatus 100 includes a housing 10 that is manufactured from a durable rigid material such as but not limited to metal. The housing 10 includes a first side 11 and second side 12 having a passage 15 formed therethrough. The passage 15 has openings on the first side 11 and second side 12 so as to permit a shaft portion of a conventional winch to be operably inserted into the passage 15. It should be understood within the scope of the present invention that the housing 10 could be formed in alternate shapes and sizes as demonstrated herein with a housing 10 having a different shape. Fundamental to any shape, size or style of the housing 10 is the passage 15 therethrough that provides the ability for a shaft portion to be journaled thereinto.

The housing 10 has operably coupled thereto an arm member 20. The arm member 20 is manufactured from a rigid material such as but not limited to metal. Arm member 20 extends outward from the housing 10 and is configured to be engaged by a user of the winch engagement apparatus 100 so as to provide leverage in order to rotationally move a shaft portion operably coupled with the passage 15. It should be understood within the scope of the present invention that the arm member 20 could be provided in alternate lengths in order to provide varying leverage. Furthermore, it is contemplated within the scope of the present invention that the arm member 20 could be configured to be releasably secured to the housing 10 and that several alternate sized arm members 20 could be provided with the winch engagement apparatus 100. The housing 10 is manufactured having the first side 11 and second side 12 wherein during the manufacturing process the first side 11 and second side 12 are welded together to complete the housing 10.

Pivotally coupled within the housing 10 in a channel 98 are engagement levers 30. The channel 98 is formed so as to movably accommodate the engagement levers 30 therein. The engagement levers 30 are pivotally coupled within the housing 10 with pins 35,36. Depending upon the style of housing 10 pins 35,36 can be either internally or externally located on the housing 10. The engagement levers 30 includes a body 31 that is manufactured from metal having an upper portion 32 and a lower portion 33. The engagement levers 30 are movable so as to be positioned in order to operably couple into the holes present on the shaft portion of a conventional winch with which the winch engagement apparatus 100 is operably coupled. Pins 35,36 include external portion 38,39 that are configured to be engaged by a user in order to set the engagement levers 30 into position for operation and engagement of a winch. During operation of the winch engagement apparatus 100 the housing 10 is rotatably positioned on a shaft portion of a winch so as to facilitate the coupling of the engagement levers 30 with the shaft portion. Force is applied to the arm member 20 and the engagement levers 30 bias against a hole or other element on a shaft portion of a conventional winch and through coupling therewith a user can rotatably move a shaft on a winch so as to tighten a strap coupled with the winch.

The lower portion 33 is shaped so as to provide self-centering of the engagement levers 30. External portions 38,39 of the pins 35,36 include keepers 45 wherein keepers 45 extend through the external portions 38,39 providing both securing of the pins 35,36 and also function as indicators of the position of the engagement levers 30 as to their position of off and on. Engagement levers 30 include a leading edge 47 having corner 48 formed to operably engage a hole on a portion of a shaft of a winch.

It should be further understood within the scope of the present invention that the engagement levers 30 could be formed from a flat metal bar having sufficient width to self-center into and aperture or a portion of round bar having the configurations described herein. It should be further understood within the scope of the present invention that the passage 15 having openings on both sides thereof provides the ability to orient the housing 10 in a desired position as either the first side 11 or second side 12 can be placed adjacent a winch so as to engage a shaft portion thereof. This allows for increased options to achieve the desired angle and as such leverage of the winch engagement apparatus 100 in order to accomplish the objective of tightening a strap operably coupled with a strap winch.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A winch engagement apparatus configured to operably coupled to a strap winch and provide operation thereof wherein the winch engagement apparatus comprises:
a housing, said housing having a first side and a second side, said housing having a hollow passage, said hollow passage extending intermediate said first side and said second side, said hollow passage having openings at said first side and said second side, said hollow passage being annular in shape so as to mateably couple with a portion of a shaft on the strap winch;
engagement levers, said engagement levers being pivotally coupled within housing, said engagement levers having a body, said body having a lower portion and an upper portion, said engagement levers shaped to facilitate penetration of a portion of the engagement levers into a hole present on a portion of a shaft of the strap winch.

2. The winch engagement apparatus as recited in claim 1, and further including an arm member, said arm member being operably coupled to said housing and extending outward therefrom.

3. The winch engagement apparatus as recited in claim 2, wherein said engagement levers are pivotally coupled with pins, said pins further having a keeper.

4. The winch engagement apparatus as recited in claim 3, wherein said engagement lever further includes a leading edge, said leading edge being proximate said upper portion of said body of said engagement lever.

5. The winch engagement apparatus as recited in claim 4, wherein said leading edge further includes a corner.

6. An apparatus configured to provide operational engagement of a strap winch secured to a flatbed trailer wherein the apparatus comprises:
a housing, said housing being manufactured from metal, said housing having a first side and a second side, said housing having extending intermediate said first side and said second side having openings at each distal end of said hollow passage, said hollow passage being annular in shape so as to facilitate insertion of a portion of a shaft on the strap winch;
engagement levers, said engagement levers being pivotally coupled to said housing, said engagement levers having a body, said body having a lower portion and an upper portion, said upper portion of said engagement levers having a leading edge, said leading edge further having a corner, said corner configured to penetrate into a hole formed on a portion of a shaft of the strap winch; and
an arm member, said arm member being secured to said housing, said arm member extending outward from said housing, said arm member configured to provide a user interface to provide rotational movement of the apparatus so as to rotate the portion of the shaft of the strap winch with which the housing is coupled.

7. The apparatus configured to provide operational engagement of a strap winch as recited in claim 6, wherein said first side of said housing and said second side are welded together.

8. The apparatus configured to provide operational engagement of a strap winch as recited in claim 7, wherein said engagement levers are pivotally coupled with pins, said pins further a keeper wherein said keeper provides indication of position of said engagement levers.

9. The apparatus configured to provide operational engagement of a strap winch as recited in claim 8, wherein said passage has openings on the first side of the housing and the second side of the housing.
